(19) United States
(12) Patent Application Publication
(10) Pub. No.: US 2025/0348245 A1
(43) Pub. Date: Nov. 13, 2025

(54) COMMAND RESPONDING METHOD, MEMORY STORAGE DEVICE AND MEMORY CONTROL CIRCUIT UNIT BY INCLUDING DATA NOT RELATED TO EXECUTION RESULT OF OPERATION COMMAND

(71) Applicant: PHISON ELECTRONICS CORP., Miaoli (TW)

(72) Inventor: Ming-Fu Lai, Miaoli (TW)

(73) Assignee: PHISON ELECTRONICS CORP., Miaoli (TW)

(21) Appl. No.: 18/673,259

(22) Filed: May 23, 2024

(30) Foreign Application Priority Data
May 7, 2024 (TW) 113116841

(51) Int. Cl. G06F 3/06

(52) U.S. Cl. CPC G06F 3/0659; G06F 3/0604; G06F 3/0679

(57) ABSTRACT

A command responding method, a memory storage device, and a memory control circuit unit are disclosed. The command responding method includes the following steps. An operation command is received from a host system. A response message is generated according to the operation command, in which the response message carries a first type response data and a second type response data, the first type response data reflects an execution result of the operation command, and the second type response data is not related to the execution result of the operation command. The response message is sent to the host system in response to the operation command.

### CROSS-REFERENCE TO RELATED APPLICATION

This application claims the priority benefit of Taiwan application serial no. 113116841, filed on May 7, 2024. The entirety of the above-mentioned patent application is hereby incorporated by reference herein and made a part of this specification.

### BACKGROUND

### Technical Field

The disclosure relates to a command responding method, a memory storage device, and a memory control circuit unit.

### Description of Related Art

Portable electronic devices such as mobile phones and notebook computers have grown rapidly in recent years, resulting in a rapid increase in consumer demand for storage media. Since rewriteable non-volatile memory modules (such as flash memory) have the characteristics of non-volatile data, power saving, small size, and no mechanical structure, they are very suitable for being built into the various portable electronic devices as exemplified above.

Generally speaking, the host system may send developer commands to the memory storage device to command the memory storage device to perform certain customized functions, such as reporting the temperature of the memory storage device, and so on. However, during the execution of commands and/or data transmission between the host system and the memory storage device, the additionally transmitted developer commands may occupy the transmission bandwidth between the host system and the memory storage device, resulting in the decaying access performance between the host system and the memory storage device. In addition, in order to process tasks related to the developer commands, additional workflows need to be configured in the host system and memory storage device, resulting in an increase in product development burden.

### SUMMARY

The disclosure provides a command responding method, a memory storage device, and a memory control circuit unit, which can improve the above issues and the efficiency of message transmission between the host system and the memory storage device.

Exemplary embodiments of the disclosure provide a command responding method for a memory storage device. The command responding method includes: receiving an operation command from a host system; generating a response message based on the operation command, in which the response message carries a first type response data and a second type response data, the first type response data reflects an execution result of the operation command, and the second type response data is not related to the execution result of the first operation command; and sending the response message to the host system to respond to the operation command.

An exemplary embodiment of the disclosure further provides a memory storage device, which includes a connection interface unit, a rewritable non-volatile memory module, and a memory control circuit unit. The connection interface unit is configured to be coupled to the host system. The memory control circuit unit is coupled to the connection interface unit and the rewritable non-volatile memory module. The memory control circuit unit is configured to: receiving the operation command from the host system; generating the response message according to the operation command, in which the response message carries the first type response data and the second type response data, the first type response data reflects the execution result of the operation command, and the second type response data is not related to the execution result of the first operation command; and sending the response message to the host system to respond to the operation command.

Example embodiments of the disclosure further provide a memory control circuit unit for controlling the memory storage device. The memory storage device includes the rewritable non-volatile memory module. The memory control circuit unit includes a host interface, a memory interface, and a memory management circuit. The host interface is configured to be coupled to the host system. The memory interface is configured to be coupled to the rewritable non-volatile memory module. The memory management circuit is coupled to the host interface and the memory interface. The memory management circuit is configured to: receiving the operation command from the host system; generating response message according to the operation command, in which the response message carries the first type response data and the second type response data, the first type response data reflects the execution result of the operation command, and the second type response data is not related to the execution result of the first operation command; and sending the response message to the host system to respond to the operation command.

Based on the above, after receiving the operation command from the host system, the response message may be generated according to the operation command. In particular, the response message may be configured to carry the first type response data and the second type response data. The first type response data may reflect the execution result of the operation command, while the second type response data is not related to the execution result of the operation command. The response message may then be sent to the host system to respond to the operation command. Thereby, the efficiency of message transmission between the host system and the memory storage device can be effectively improved.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of managing a rewritable non-volatile memory module according to an exemplary embodiment of the disclosure.

FIG. 7 is a schematic diagram of filling the first type response data and the second type response data into the response message according to an exemplary embodiment of the disclosure.

FIG. 8 is a schematic diagram of updating status data at multiple time points according to an exemplary embodiment of the disclosure.

FIG. 9 is a flowchart of a command responding method according to an exemplary embodiment of the disclosure.

### DESCRIPTION OF THE EMBODIMENTS

Generally speaking, a memory storage device (also known as a memory storage system) includes a rewritable non-volatile memory module and a controller (also known as a control circuit). The memory storage device may be used with a host system such that the host system may write data to the memory storage device or read data from the memory storage device.

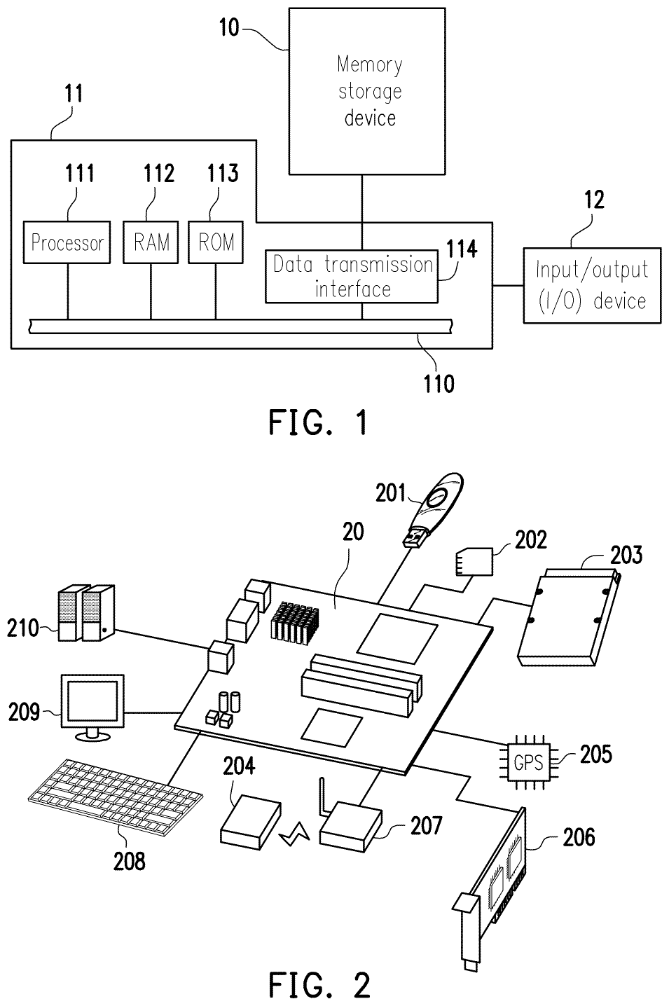

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIGS. 1 and 2, a host system 11 may include a processor 111, a random access memory (RAM) 112, a read only memory (ROM) 113, and a data transmission interface 114. The processor 111, the random access memory 112, the read only memory 113 and the data transmission interface 114 may be coupled to a system bus 110.

In an example embodiment, the host system 11 may be coupled to the memory storage device 10 through the data transmission interface 114. For example, the host system 11 may store data to the memory storage device 10 or read data from the memory storage device 10 through the data transfer interface 114. In addition, the host system 11 may be coupled to an I/O device 12 through the system bus 110. For example, the host system 11 may transmit output signals to the I/O device 12 or receive input signals from the I/O device 12 via the system bus 110.

In an exemplary embodiment, the processor 111, the random access memory 112, the read only memory 113, and the data transmission interface 114 may be disposed on a motherboard 20 of the host system 11. The number of the data transmission interfaces 114 may be one or more. Through the data transmission interface 114, the motherboard 20 may be coupled to the memory storage device 10 through a wired or wireless manner.

In an exemplary embodiment, the memory storage device 10 may be, for example, a flash drive 201, a memory card 202, a solid state drive (SSD) 203, or a wireless memory storage device 204. The wireless memory storage device 204 may be, for example, a near field communication (NFC) memory storage device, a wireless fax (WiFi) memory storage device, a Bluetooth memory storage device, or a Bluetooth low energy memory storage devices (such as iBeacon) and other memory storage devices based on various wireless communication technologies. In addition, the motherboard 20 may also be coupled to various I/O devices such as a global positioning system (GPS) module 205, a network interface card 206, a wireless transmission device 207, a keyboard 208, a screen 209, a speaker 210, etc. through the system bus 110. For example, in an exemplary embodiment, the motherboard 20 may access the wireless memory storage device 204 through the wireless transmission device 207.

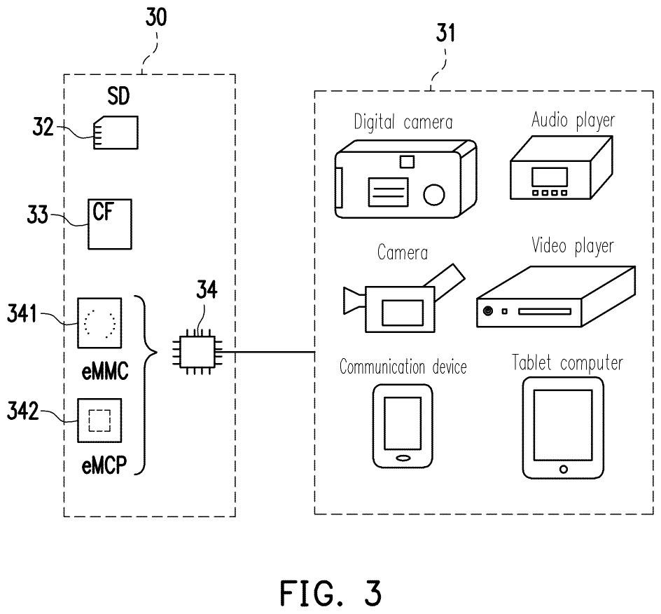

In an exemplary embodiment, the host system 11 is a computer system. In an example embodiment, the host system 11 may be any system that may substantially cooperate with a memory storage device to store data. In an example embodiment, the memory storage device 10 and the host system 11 may include a memory storage device 30 and a host system 31 of FIG. 3 respectively.

FIG. 3 is a schematic diagram of a host system and a memory storage device according to an exemplary embodiment of the disclosure. Referring to FIG. 3, the memory storage device 30 may be used in conjunction with the host system 31 to store data. For example, the host system 31 may be systems such as a digital camera, a video camera, a communication device, an audio player, a video player, or a tablet computer. For example, the memory storage device 30 may be various non-volatile memory storage devices such as a secure digital (SD) card 32, a compact flash (CF) card 33, or an embedded storage device 34 used by the host system 31. The embedded storage device 34 includes various embedded storage devices that directly coupled the memory module to a substrate of the host system such as an embedded multi media card (eMMC) 341 and/or an embedded multi chip package (eMCP) storage device 342, etc.

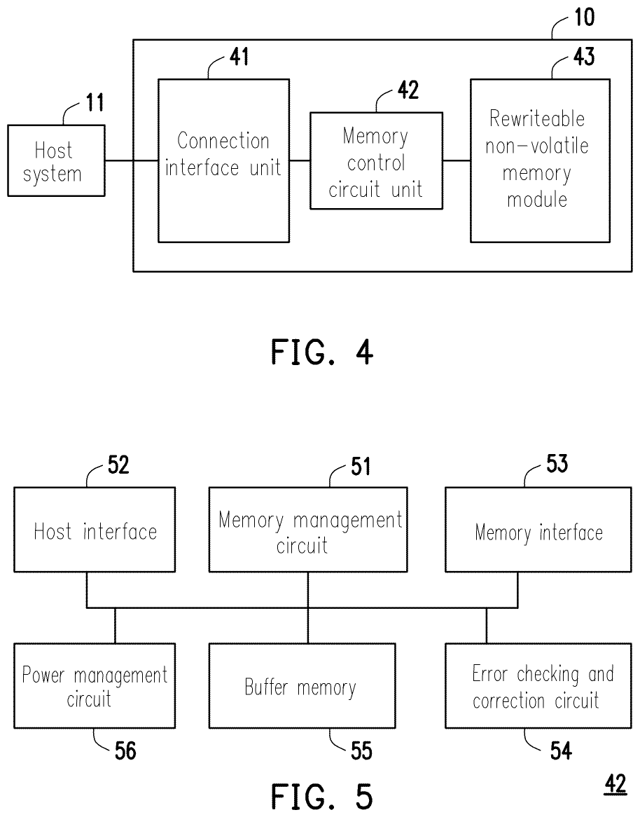

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is used to be coupled to the host system 11. The memory storage device 10 may communicate with the host system 11 via the connection interface unit 41. In an exemplary embodiment, the connection interface unit 41 is compatible with the peripheral component interconnect express (PCI Express) standard. In an exemplary embodiment, the connection interface unit 41 may also be compliant with a serial advanced technology attachment (SATA) standard, a parallel advanced technology attachment (PATA) standard, an institute of electrical and electronic engineers (IEEE) 1394 standard, an universal serial bus (USB) standard, a SD interface standard, an ultra high speed-I (UHS-I) interface standard, an ultra high speed-II (UHS-II) interface standard, a memory stick (MS) interface standard, a MCP interface standard, a MMC interface standard, an eMMC interface standard, an universal flash storage (UFS) interface standard, an eMCP interface standard, a CF interface standard, an integrated device electronics (IDE) standard or other suitable standards. The connection interface unit 41 and the memory control circuit unit 42 may be packaged in a chip, or the connection interface unit 41 may be arranged outside a chip including the memory control circuit unit 42.

The memory control circuit unit 42 is coupled to the connection interface unit 41 and the rewritable non-volatile memory module 43. The memory control circuit unit 42 is used to execute multiple logic gates or control commands implemented in hardware mode or firmware mode and perform operations of data writing, reading, and erasing in the rewritable non-volatile memory module 43 according to the commands of the host system 11.

The rewritable non-volatile memory module 43 is used to store data written by the host system 11. The rewritable non-volatile memory module 43 may include a single level cell (SLC) NAND flash memory module (i.e., a flash memory module that may store 1 bit in one memory cell), a multi level cell (MLC) NAND flash memory module (i.e., a flash memory module that may store 2 bits in one memory cell), a triple level cell (TLC) NAND flash memory module (i.e., a flash memory module that may store 3 bits in one memory cell), a quad level cell (QLC) NAND flash memory module (i.e., flash memory modules that may store 4 bits in one memory cell), other flash memory modules, or other memory modules with the same characteristics.

Each memory cell in the rewritable non-volatile memory module 43 stores one or more bits based on changes in voltage (hereinafter also referred to as a threshold voltage). Specifically, there is a charge-trapping layer between a control gate and a channel of each memory cell. By applying a writing voltage to the control gate, the amount of electrons in the charge-trapping layer may be changed, thereby changing the threshold voltage of the memory cell. This operation of changing the threshold voltage of the memory cell is also called “writing data into the memory cell” or “programming the memory cell”. As the threshold voltage changes, each of the memory cells in the rewritable non-volatile memory module 43 has multiple storage states. By applying a reading voltage, it is possible to determine which storage state a memory cell belongs to, thereby receiving one or more bits stored in the memory cell.

In an exemplary embodiment, the memory cells of the rewritable non-volatile memory module 43 may constitute multiple physical programming units, and the physical programming units may constitute multiple physical erasing units. Specifically, the memory cell on the same character line may form one or more physical programming units. In response to each memory cell storing more than 2 bits, the physical programming units on the same character line may at least be classified into lower physical programming units and upper physical programming units. For example, a least significant bit (LSB) of a memory cell belongs to the lower physical programming unit, and a most significant bit (MSB) of a memory cell belongs to the upper physical programming unit. Generally speaking, in the MLC NAND flash memory, a writing speed of the lower physical programming unit is greater than a writing speed of the upper physical programming unit, and/or a reliability of the lower physical programming unit is higher than a reliability of the upper physical programming unit.

In an example embodiment, the physical programming unit is the smallest unit of programming. That is, the physical programming unit is the smallest unit for writing data. For example, the physical programming unit may be a physical page or a physical sector. In response to the physical programming unit being physical pages, the physical programming unit may include a data bit area and a redundancy bit area. The data bit area includes multiple physical sectors to store user data, while the redundancy bit area is used to store system data (for example, management data such as error correction codes). In an example embodiment, the data bit area includes 32 physical sectors, and the size of one physical sector is 512 bytes (B). However, in other exemplary embodiments, the data bit area may also include 8, 16, or more or less physical sectors, and the size of each of the physical sectors may also be larger or smaller. On the other hand, the physical erasing unit is the smallest unit of erasing. That is, each of the physical erasing units contains the minimum number of erased memory cells. For example, the physical erasing unit is a physical block.

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is used to control an overall operation of the memory control circuit unit 42. Specifically, the memory management circuit 51 has the multiple control commands. During operation of the memory storage device 10, the control commands are executed to perform operations such as writing, reading, and erasing data. Hereinafter, when the operation of the memory management circuit 51 is descried, the operation of the memory control circuit unit 42 and the memory storage device 10 is equivalently described.

In an exemplary embodiment, the control commands of the memory management circuit 51 are implemented in a firmware form. For example, the memory management circuit 51 has a microprocessor unit (not shown) and a read-only memory (not shown), and the control commands are programmed into the read-only memory. During operation of the memory storage device 10, the control commands are executed by the microprocessor unit to perform operations such as writing, reading, and erasing data.

In an exemplary embodiment, the control commands of the memory management circuit 51 may also be stored in a form of programming code in a specific area (e.g., a system area dedicated to storing system data in the memory module) of the rewritable non-volatile memory module 43. In addition, the memory management circuit 51 has a microprocessor unit (not shown), a read-only memory (not shown), and a random access memory (not shown). In particular, the read-only memory has a boot code, and when the memory control circuit unit 42 is enabled, the microprocessor unit executes the boot code first to load the control commands stored in the rewritable non-volatile memory module 43 into the random access memory of the memory management circuit 51. Afterwards, the microprocessor unit runs the control commands to perform operations such as writing, reading, and erasing data.

In an exemplary embodiment, the control commands of the memory management circuit 51 may also be implemented in a hardware form. For example, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is used to manage the memory cells or memory cell groups of the rewritable non-volatile memory module 43. The memory writing circuit is used to issue a writing command sequence to the rewritable non-volatile memory module 43 to write data into the rewritable non-volatile memory module 43. The memory reading circuit is used to issue a reading command sequence to the rewritable non-volatile memory module 43 to read data from the rewritable non-volatile memory module 43. The memory erasure circuit is used to issue an erasing command sequence to the rewritable non-volatile memory module 43 to erase data from the rewritable non-volatile memory module 43. The data processing circuit is used to process data to be written to the rewritable non-volatile memory module 43 and data to be read from the rewritable non-volatile memory module 43. The write command sequence, the read command sequence, and the erase command sequence may each include one or more program codes or command codes and are used to command the rewritable non-volatile memory module 43 to perform corresponding operations such as writing, reading, and erasing. In an exemplary embodiment, the memory management circuit 51 may also issue other types of command sequences to the rewritable non-volatile memory module 43 to command the execution of corresponding operations.

The host interface 52 is coupled to the memory management circuit 51. The memory management circuit 51 may communicate with the host system 11 through the host interface 52. The host interface 52 may be used to receive and identify commands and data sent by the host system 11. For example, the commands and the data sent by the host system 11 may be sent to the memory management circuit 51 through the host interface 52. In addition, the memory management circuit 51 may transmit data to the host system 11 through the host interface 52. In this exemplary embodiment, the host interface 52 is compliant with the PCI Express standard. However, it should be understood that the disclosure is not limited thereto. The host interface 52 may also be compatible with the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard or other suitable data transmission standards.

The memory interface 53 is coupled to the memory management circuit 51 and used to access the rewritable non-volatile memory module 43. For example, the memory management circuit 51 may access the rewritable non-volatile memory module 43 through the memory interface 53. That is to say, the data to be written to the rewritable non-volatile memory module 43 is converted into a format acceptable to the rewritable non-volatile memory module 43 through the memory interface 53. Specifically, in response to the memory management circuit 51 being to access the rewritable non-volatile memory module 43, the memory interface 53 sends a corresponding command sequence. For example, the command sequences may include the writing command sequence commanding to write data, the read command sequence commanding to read data, the erasing command sequence commanding to erase data, and the corresponding command sequence commanding various memory operations (e.g., changing a read voltage level or perform a garbage collection (GC) operation, etc.). The command sequences are generated, for example, by the memory management circuit 51 and transmitted to the rewritable non-volatile memory module 43 through the memory interface 53. The command sequences may include one or more signals or data on the bus. The signals or the data may include command codes or program codes. For example, in the reading command sequence, information such as read identification codes and memory addresses is included.

In an exemplary embodiment, the memory control circuit unit 42 further includes an error checking and correcting circuit 54, a buffer memory 55, and a power management circuit 56.

The error checking and correcting circuit 54 is coupled to the memory management circuit 51 and is used to perform error checking and correcting operations to ensure the accuracy of the data. Specifically, when the memory management circuit 51 receives the writing command from the host system 11, the error checking and correcting circuit 54 generates a corresponding error correcting code (ECC) and/or an error detecting code (EDC) for the data corresponding to the writing command, and the memory management circuit 51 writes the data corresponding to the writing command and the corresponding error correcting code and/or the error detecting code into the rewritable non-volatile memory module 43. Afterwards, when reading the data from the rewritable non-volatile memory module 43, the memory management circuit 51 simultaneously reads the error correcting code and/or the error detecting code corresponding to the data, and the error checking and correcting circuit 54 performs the error checking and correcting operation on the read data according to the error correcting code and/or the error detecting code. For example, the error checking and correcting circuit 54 may use a low density parity check code (LDPC code), a BCH code, a Reed-Solomon code (RS code), an exclusive OR, XOR code and other encoding/decoding algorithms to encode and decode data.

The buffer memory 55 is coupled to the memory management circuit 51 and used to temporarily store data. The power management circuit 56 is coupled to the memory management circuit 51 and used to control a power supply of the memory storage device 10.

In an example embodiment, the rewritable non-volatile memory module 43 of FIG. 4 may include the flash memory module. In an example embodiment, the memory control circuit unit 42 of FIG. 4 may include a flash memory controller. In an example embodiment, the memory management circuit 51 of FIG. 5 may include a flash memory management circuit.

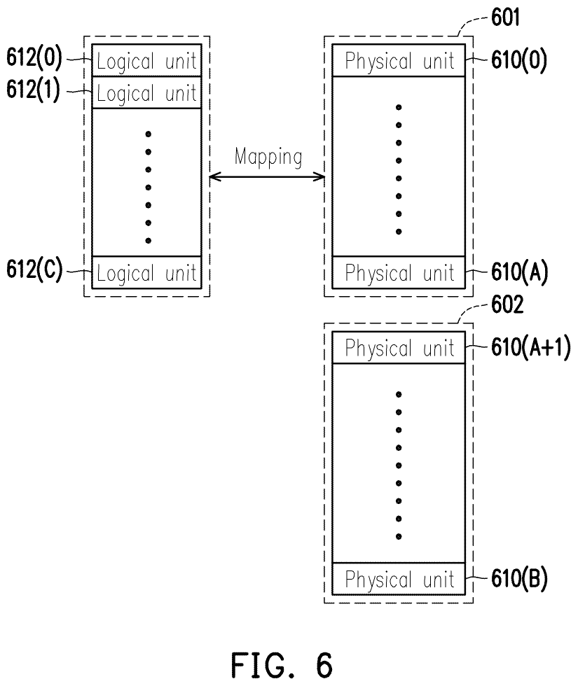

FIG. 6 is a schematic diagram of managing a rewritable non-volatile memory module according to an exemplary embodiment of the disclosure. Referring to FIG. 6, the memory management circuit 51 may logically group physical units 610(0)-610(B) in the rewritable non-volatile memory module 43 to a storage area 601 and a spare area 602.

In an example embodiment, one physical unit refers to one physical address or one physical programming unit. In an example embodiment, one physical unit may also be composed of multiple continuous or discontinuous physical addresses. In an example embodiment, one physical unit may also refer to one virtual block (VB). One virtual block may include multiple physical addresses or multiple physical programming units. In an example embodiment, one virtual block may include one or more physical erasing units.

In an exemplary embodiment, the physical units 610(0)-610(A) in the storage area 601 are used to store user data (e.g., the user data from the host system 11 of FIG. 1). For example, the physical units 610(0)-610(A) in the storage area 601 may store valid data and invalid data. The physical units 610 (A+1) to 610 (B) in the spare area 602 do not store data (e.g., the valid data). For example, in response to a certain physical unit not storing the valid data, the physical unit may be associated (or added) to the spare area 602. In addition, the physical units in the spare area 602 (or the physical units that do not store valid data) may be erased. When writing new data, one or more physical units may be retrieved from the spare area 602 to store the new data. In an example embodiment, the spare area 602 is also called a free pool.

In an exemplary embodiment, the memory management circuit 51 may be configure with logical units 612(0)-612(C) to map the physical units 610(0)-610(A) in the storage area 601. In an example embodiment, each of the logical units corresponds to one logical address. For example, one logical address may include one or more logical block addresses (LBA) or other logical management units. In an example embodiment, one logical unit may also correspond to one logical programming unit or be composed of multiple continuous or discontinuous logical addresses.

It should be noted that one logical unit may be mapped to one or more physical units. In response to a certain physical unit being currently mapped by a certain logical unit, it means that the data currently stored in the physical unit includes the valid data. On the contrary, in response to a certain physical unit being not currently mapped by any logical unit, it means that the data currently stored in the physical unit is the invalid data.

In an exemplary embodiment, the memory management circuit 51 may record management data describing a mapping relationship between the logical units and the physical units (also referred to as logical-to-physical mapping information) in at least one logical-to-physical mapping table (L2P table). When the host system 11 is to read data from or write data to the memory storage device 10, the memory management circuit 51 may access the rewritable non-volatile memory module 43 according to the information in the L2P table.

In an exemplary embodiment, the memory management circuit 51 may receive an operation command from the host system. The operation command is used to command the memory storage device 10 to perform a specific operation. For example, the operation command may include one of the writing command, the reading command, and the erasing command. The writing command is used to command the memory storage device 10 to perform a writing operation to store specific data in the memory storage device 10 (or the rewritable non-volatile memory module 43). The reading command is used to command the memory storage device 10 to perform a reading operation to read specific data from the memory storage device 10 (or the rewritable non-volatile memory module 43). The erasing command is used to command the memory storage device 10 to perform an erasing operation to erase specific data from the memory storage device 10 (or the rewritable non-volatile memory module 43). In addition, the operation commands may also include other types of operation commands and be used to command the memory storage device 10 to perform other types of operations, which are not limited by the disclosure.

In an example embodiment, after receiving the operation command, the memory management circuit 51 may execute the operation command. For example, in response to the operation command being the writing command, after executing the operation command, the memory management circuit 51 may send the writing command sequence to the rewritable non-volatile memory module 43 to command the rewritable non-volatile memory module 43 to store the specific data in the rewritable non-volatile memory module 43. In response to the operation command being the reading command, after executing the operation command, the memory management circuit 51 may send the reading command sequence to the rewritable non-volatile memory module 43 to command the rewritable non-volatile memory module 43 to read the specific data from the rewritable non-volatile memory module 43. Alternatively, in response to the operation command being the erasing command, after executing the operation command, the memory management circuit 51 may send the erasing command sequence to the rewritable non-volatile memory module 43 to command the rewritable non-volatile memory module 43 to erase the specific data from the rewritable non-volatile memory module 43.

In an example embodiment, the memory management circuit 51 may generate a response message according to the operation command. It should be noted that the response message may be used to carry different types of response data. For example, the response message may carry a first type response data and a second type response data. The first type response data may reflect an execution result of the operation command. In addition, the second type response data has nothing to do with the execution result of the operation command.

In an example embodiment, the first type response data may reflect whether the execution result of the operation command is successful or failed. For example, in response to the operation command being the writing command, the first type response data may reflect whether the writing operation performed by the memory storage device 10 corresponding to the operation command is successful or failed. In response to the operation command being the reading command, the first type response data may reflect whether the reading operation performed by the memory storage device 10 corresponding to the operation command is successful or failed. Alternatively, in response to the operation command being the erasing command, the first type response data may reflect whether the erasing operation performed by the memory storage device 10 corresponding to the operation command is successful or failed. In addition, in response to the operation command is the reading command, the first type response data may further include the data reading from the memory storage device 10 (or from the rewritable non-volatile memory module 43) as commanded by the reading command. It should be noted that the first type response data may further be used to transmit any information related to the execution results of the operation commands back to the host system, and the disclosure does not limit the data type of the first type response data.

In an example embodiment, the second type response data may reflect the status of the memory storage device 10 before receiving the operation command or generating the response message. Therefore, the status of the memory storage device 10 reflected by the second type response data has nothing to do with the operation command. In an example embodiment, the status may include a temperature status and/or a working status of the memory storage device 10. In an example embodiment, the second type response data may also reflect any status of the memory storage device 10 before receiving the operation command or generating the response message, and is not limited to the temperature status and working status.

In an example embodiment, the second type response data may include one or more temperature codes. The temperature code may reflect the temperature status of the memory storage device 10 within a time period before the operation command is received or the response message is generated. For example, the temperature code may reflect a temperature of the memory storage device 10 measured by a temperature sensor (not shown) in the memory storage device 10 within the time period. In an exemplary embodiment, the temperature code may reflect a maximum temperature, a minimum temperature, and/or an average temperature of at least one of the connection interface unit 41, the memory control circuit unit 42, and the rewritable non-volatile memory module 43 measured within a certain time period.

In an example embodiment, the second type response data may include one or more status codes. The status code may reflect the working status of the memory storage device 10 within the time period before receiving the operation command or generating the response message. For example, the status code may reflect an execution status of an internal operation performed by the memory storage device 10 within the time period. For example, the internal operation may include at least one of data reading operations, data writing operations, data erase operations, garbage collection (GC) operations, wear leveling (WL) operations, bad block management operations, data refresh operations, data decoding operations, and program code switching operations.

Specifically, the data reading operation is used to read data from a specific physical unit in the rewritable non-volatile memory module 43. The data writing operation is used to write data to a specific physical unit in the rewritable non-volatile memory module 43. The data erasing operation is used to erase data from a specific physical unit in the rewritable non-volatile memory module 43. The garbage collection operation, the wear leveling operation, the bad block management operation, and the data refresh operation are used to move or copy data from a source physical unit to a target physical unit to achieve such as concentration of the valid data, classification management of the physical unit, and/or improving the health of the stored data, etc. The data decoding operation is used to decode data read from the specific physical unit in the rewritable non-volatile memory module 43 to correct errors in the data. The program code switching operation is used to switch the program code used by the memory management circuit 51 (or the memory control circuit unit 42) according to different operating requirements. However, those skilled in the art should be aware of the operational details of the above various internal operations, which are not repeated herein. In addition, the memory storage device 10 may also perform other types of internal operations, which are not limited by the disclosure.

In an exemplary embodiment, the status codes in the second type response data may reflect the execution status of various internal operations performed by the memory storage device 10 within the time period. For example, one status code may reflect the number of times the specific type of internal operation is performed within the time period. For example, one status code may reflect the number of times the specific type of internal operation is successfully executed or the number of times of being failed within the time period. Taking the data decoding operation as an example, one status code in the second type response data may reflect the number of times the data decoding operation is executed, the number of times the data decoding operation is successfully executed, or the number of times the data decoding operation is not successfully executed within the time period. In addition, the status code may also reflect any execution status related to the internal operations, which is not limited by the disclosure.

In an example embodiment, after generating the response message including the first type response data and the second type response data, the memory management circuit 51 may transmit the response message to the host system 11 to respond to the operation command. After receiving the response message, the host system 11 may analyze the response message and receive the first type response data and the second type response data from the response message. For example, the host system 11 may receive the execution result of the operation command of the memory storage device 10 based on the first type response data. In addition, the host system 11 may receive the status (such as the temperature status and/or the working status) of the memory storage device 10 currently or within a previous time period based on the second type response data.

In an example embodiment, the response message includes a data area and a reserved bit area. In an example embodiment, during a generation of the response message, the memory management circuit 51 may store the first type response data in the data area in the response message and store the second type response data in the reserved bit area in the response message. It should be noted that according to the specifications of a data transmission protocol adopted by the host system 11 and the memory storage device 10, the reserved bit area in the response message may be flexibly configured and used by both the host system 11 and the memory storage device 10. In other words, the data transmission protocol adopted by the host system 11 and the memory storage device 10 does not specifically define the function and/or purpose of the reserved bit area in the response message.

In an example embodiment, after receiving the operation command from the host system, the memory management circuit 51 may detect an event for generating the response message. In response to the event, the memory management circuit 51 may read data (also called status data) from at least one register (also called a status register). The status data may reflect the status of the memory storage device 10. For example, the status data may reflect the status of the memory storage device 10 before receiving the operation command or generating the response message. Then, during the generation of the response message, the memory management circuit 51 may fill the second type response data into the generated response message according to the status data.

In an example embodiment, the status register is dedicated to storing the status data. For example, before receiving the operation command from the host system 11 or generating the response message, the memory management circuit 51 may continuously detect the status of the memory storage device 10 (such as the temperature status and/or the working status) and write the status data into the status register according to the detected status. Thereafter, when the event for generating the response message is detected, the memory management circuit 51 may read the status data from the status register and fill the second type response data in the reserved bit area in the response message according to the status data. In addition, during the generation of the response message, the memory management circuit 51 may fill the first type response data into the data area in the response message according to the execution result of the operation command. Thereafter, the response message carrying the first type response data and the second type response data may be sent to the host system 11 to respond to the operation command.

In an example embodiment, the status register includes multiple storage areas (also called sub-storage areas), and the response message includes multiple reserved bit areas. The memory management circuit 51 may fill a part of data (also called a first sub-data) of the second type response data in one reserved bit area (also called a first reserved bit area) in the response message according to the status data (also referred to as a first status data) read from one sub-storage area (also referred to as a first sub-storage area) in the status register. On the other hand, the memory management circuit 51 may fill another part of data (also called a second sub-data) of the send type response data in another reversed bit area (also called a second reserved bit area) in the response message according to the state data (also called a second state data) read from another sub-storage area (also called a second sub-storage area) in the status register. The first sub-storage area is different from the second sub-storage area, and the first reserved bit area is different from the second reserved bit area.

In an example embodiment, the first status data and the second status data may be used to describe the status of different types of memory storage devices 10. For example, in an exemplary embodiment, the first status data may be used to describe the temperature status of the memory storage device 10 and/or the second status data may be used to describe the working status of the memory storage device 10. Alternatively, in an exemplary embodiment, the first status data may be used to describe an execution status (also called a first execution state) of one type of internal work (also called a first type internal work) of the memory storage device 10, and/or the second status data may be used to describe the execution status (also called a second execution status) of another type of internal work (also called a second type internal work) of the memory storage device 10. For example, the first type internal work and the second type internal work may be two of the data reading operation, the data writing operation, the data erasing operation, the garbage collection operation, the wear leveling operation, the bad block management operation, the data refreshing operation, the data decoding operations, and code switching operations, respectively. The types of the first type internal work and/or the second type internal work are not limited thereto.

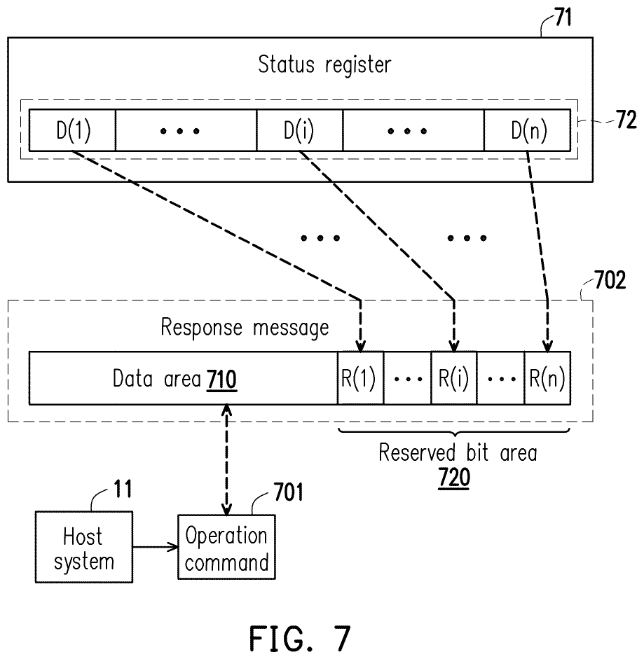

FIG. 7 is a schematic diagram of filling the first type response data and the second type response data into the response message according to an exemplary embodiment of the disclosure. Referring to FIG. 7, in an exemplary embodiment, the memory management circuit 51 may be configured with a status register 71. Before receiving an operation command 701 from the host system 11 or generating a response message 702, the memory management circuit 51 may continuously detect the status of the memory storage device 10 and write q status data 72 into the status register 71 according to the detected status. For example, the status data 72 includes multiple status data D(1)-D(n). The status data D(1)-D(n) may be used to reflect the status of different types of memory storage devices 10 (such as the temperature status and/or the working status).

In an exemplary embodiment, after receiving the operation command 701 from the host system 11, the memory management circuit 51 may execute the operation command 701 and generate the response message 702. It should be noted that during the generation of the response message 702, the memory management circuit 51 may fill the first type response data into a data area 710 in the response message 702 according to the execution result of the operation command 701. This first type response data may reflect the execution result of the operation command 701.

On the other hand, during the generation of the response message 702, the memory management circuit 51 may read the status data 72 from the status register 71 and fill the second type response data into a reserved bit area 720 in the response message 702 according to the status data 72. For example, the reserved bit area 720 includes reserved bit areas R(1)-R(n).

In an exemplary embodiment, the memory management circuit 51 may fill the status data D(1)-D(n) into the reserved bit areas R(1)-R(n), respectively. In an example embodiment, the memory management circuit 51 may also fill a part of the status data D(1)-D(n) into the reserved bit area 720. For example, in response to a status data D(i) not existing or not being updated, the memory management circuit 51 may not fill the status data D(i) into a reserved bit area R(i). After generating the response message 702, the memory management circuit 51 may send the response message 702 to the host system 11 to response to the operation command 701.

In an exemplary embodiment, storage locations of the status data D(1)-D(n) in the reserved bit areas R(1)-R(n) are predefined. For example, the reversed bit area R(i) is exclusively for storing the status data D(i). Thereby, after the host system 11 receives the response message 702, the host system 11 may receive or evaluate the status in one aspect of the memory storage according to the status data D(i) (i.e., the second type response data) stored in the reserved bit area R(i). In addition, the host system 11 may also receive the execution result of the operation command 701 by the memory storage device 10 based on the first type response data stored in the data area 710.

It should be noted that in the exemplary embodiment of FIG. 7, a data format of the response message 702 (i.e., the configuration of the data area 710 and the reserved bit area 720) is only an example. In an exemplary embodiment, the data format of the response message 702 (i.e., the configuration of the data area 710 and the reserved bit area 720) may also be adjusted according to practical needs, which is not limited by the disclosure.

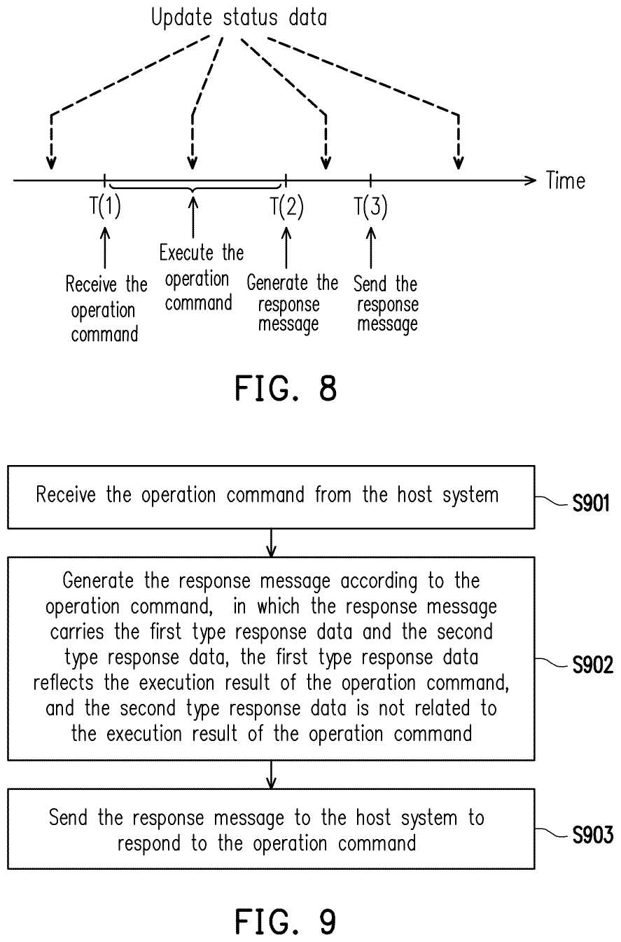

FIG. 8 is a schematic diagram illustrating updating status data at multiple time points according to an exemplary embodiment of the disclosure. Referring to FIG. 7 and FIG. 8, it is assumed that the memory management circuit 51 receives the operation command 701 from the host system 11 at a time point T(1) and starts to generate the response message 702 corresponding to the operation command 701 at a time point T(2). Between the time points T(1) and T(2), the memory management circuit 51 may execute the operation command 701. Finally, the memory management circuit 51 may send a response message 702 to the host system 11 at a time point T(3) to respond to the operation command 701.

In an exemplary embodiment, the memory management circuit 51 may update the status data 72 in the status register 71 before receiving the operation command 701 (i.e., before the time point T(1)), during the execution of the operation command 701 (i.e., between the time points T(1) and T(2)), during the generation of the response message 702 (i.e., between the time points T(2) and T(3)), and/or any time point after sending the response message 702 (i.e., after the time point T(3)). Alternatively, from another perspective, the time point at which the status data 72 in the status register 71 is updated is only affected by the update rules of the status data 72 by the memory management circuit 51, and is not affected by whether the operation command 701 is received and/or whether the response message 702 is generated.

In an example embodiment, update rules for the status data 72 of the memory management circuit 51 may include updating the status data 72 in the status register 71 every a preset time period, and/or updating the status data D(i) in the status register 71 individually every time the status related to the status data D(i) in the memory storage device 10 changes. However, the update rules may be adjusted according to practical needs and are not limited by the disclosure.

In an example embodiment, the reserved bit area in the response message may further store an identification data. For example, the identification data may include one or more bits (also called identification bits). This identification data may be used to notify the host system 11 whether the response message currently received carries the second type response message. For example, assuming that the identification data in one response message is set as specific data (also called a first identification data), it means that the response message carries the second type response message. Alternatively, assuming that the identification data in one response message is set as another data (also called a second identification data), it means that the response message does not carry the second type response message.

In an exemplary embodiment, during the generation of the response message (also referred to as the first response message), the memory management circuit 51 may fill the second type response data together with the first identification data into the reserved bit area in the first response message. Then, the memory management circuit 51 may send the first response message to the host system 11. After receiving the first response message, the host system 11 may further read the second type response message from the first response message according to the first identification data in the first response message.

In an exemplary embodiment, during the generation of the response message (also referred to as the second response message), the memory management circuit 51 may fill the second identification data into the reserved bit area in the second response message, without filling the second type response message into the reserved bit area in the second response message. Then, the memory management circuit 51 may send the second response message to the host system 11. After receiving the second response message, the host system 11 may skip (i.e., not perform) the operation of reading the second type response message from the second response message according to the second identification data in the response message.

In an exemplary embodiment, the operation of filling the second type response data into the response message may also be performed by an additionally configured hardware circuit instead of the memory management circuit 51. In an exemplary embodiment, the operation of filling the first type response data and the second type response data into the response message (or the operation of generating the response message) may be performed by the additionally configured hardware circuit.

FIG. 9 is a flowchart of a command responding method according to an exemplary embodiment of the disclosure. Referring to FIG. 9, in step S901, the operation command is received from the host system. In step S902, the response message is generated according to the operation command. The response message carries the first type response data and the second type response data. The first type response data reflects the execution result of the operation command, and the second type response data has nothing to do with the execution result of the operation command. In step S903, the response message is sent to the host system to respond to the operation command.

However, each step in FIG. 9 has been described in detail above, which is not repeated herein. It is worth noting that each step in FIG. 9 may be implemented as multiple program codes or circuits, and the disclosure is not limited thereto. In addition, the method in FIG. 9 may be used in conjunction with the example embodiments or may be used alone, and the disclosure is not limited thereto.

To sum up, the command responding method, the memory storage device, and the memory control circuit unit proposed by the exemplary embodiments of the disclosure may entrain information unrelated to the operation command from the host system in the response message responding to the operation command. Thereby, the bandwidth used to transmit additional status data between the host system and the memory storage device can be effectively reduced, improving the efficiency of message transmission between the host system and the memory storage device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A command responding method for a memory storage device, wherein the command responding method comprises:
receiving an operation command from a host system;
after executing the operation command, generating a response message according to the operation command, wherein the response message carries a first type response data and a second type response data, the first type response data reflects an execution result of the operation command, and the second type response data is not related to the execution result of the operation command; and
sending the response message to the host system to respond to the operation command.

2. The command responding method according to claim 1, wherein the operation command comprises one of a writing command, a reading command, and an erasing command.

3. The command responding method according to claim 1, wherein the second type response data reflects a status of the memory storage device before receiving the operation command or generating the response message.

4. The command responding method according to claim 3, wherein the status comprises at least one of a temperature status and a working status.

5. The command responding method according to claim 1, wherein the second type response data is stored in a reserved bit area in the response message.

6. The command responding method according to claim 1, wherein generating the response message according to the operation command comprises:
detecting an event configured to generate the response message;
reading a status data from a status register in response to the event, wherein the status data reflects a status of the memory storage device; and
filling the second type response data into the response message according to the status data during a generation of the response message.

7. The command responding method according to claim 6, further comprising:
writing the status data into the status register before detecting the event configured to generate the response message.

8. The command responding method according to claim 6, further comprising:
writing the status data into the status register before receiving the operation command.

9. The command responding method according to claim 6, wherein the status register comprises a plurality of sub-storage areas, the response message comprises a plurality of reserved bit areas, wherein filling the second type response data into the response message according to the status data comprises:
filling a first sub-data in the second type response data into a first reserved bit area in the response message according to a first status data read from a first sub-storage area in the plurality of sub-storage areas; and
filling a second sub-data in the second type response data into a second reserved bit area in the response message according to a second status data read from a second sub-storage area in the plurality of sub-storage areas,
wherein the first sub-storage area is different from the second sub-storage area, and the first reserved bit area is different from the second reserved bit area.

10. A memory storage device, comprising:
a connection interface unit, configured to be coupled to a host system;
a rewritable non-volatile memory module; and
a memory control circuit unit, coupled to the connection interface unit and the rewritable non-volatile memory module,
wherein the memory control circuit unit is configured for:
receiving an operation command from a host system;
after executing the operation command, generating a response message according to the operation command, wherein the response message carries a first type response data and a second type response data, the first type response data reflects an execution result of the operation command, and the second type response data is not related to the execution result of the operation command; and
sending the response message to the host system to respond to the operation command.

11. The memory storage device according to claim 10, wherein the operation command comprise one of a writing command, a reading command, and an erasing command.

12. The memory storage device according to claim 10, wherein the second type response data reflects a status of the memory storage device before receiving the operation command or generating the response message.

13. The memory storage device according to claim 12, wherein the status comprises at least one of a temperature status and a working status.

14. The memory storage device according to claim 10, wherein the second type response data is stored in a reserved bit area in the response message.

15. The memory storage device according to claim 10, wherein generating a response message according to the operation command by the memory control circuit unit comprises:
detecting an event configured to generate the response message;
reading a status data from a status register in response to the event, wherein the status data reflects a status of the memory storage device; and
filling the second type response data into the response message according to the status data during a generation of the response message.

16. The memory storage device according to claim 15, wherein the memory control circuit unit is further configured for:
writing the status data into the status register before detecting the event configured to generate the response message.

17. The memory storage device according to claim 15, wherein the memory control circuit unit is further configured for:
writing the status data into the status register before receiving the operation command.

18. The memory storage device according to claim 15, wherein the status register comprises a plurality of sub-storage areas, the response message comprises a plurality of reserved bit areas, wherein filling the second type response data into the response message according to the status data by the memory control circuit unit comprises:
filling a first sub-data in the second type response data into a first reserved bit area in the response message according to a first status data read from a first sub-storage area in the plurality of sub-storage areas; and
filling a second sub-data in the second type response data into a second reserved bit area in the response message according to a second status data read from a second sub-storage area in the plurality of sub-storage areas,
wherein the first sub-storage area is different from the second sub-storage area, and the first reserved bit area is different from the second reserved bit area.

19. A memory control circuit unit, configured to control a memory storage device, wherein the memory storage device comprises a rewritable non-volatile memory module, and the memory control circuit unit comprises:
a host interface, configured to be coupled to a host system;
a memory interface, configured to be coupled to the rewritable non-volatile memory module; and
a memory management circuit, coupled to the host interface and the memory interface,
wherein the memory management circuit is configured to:
receiving an operation command from the host system;
after executing the operation command, generating a response message according to the operation command, wherein the response message carries a first type response data and a second type response data, wherein the first type response data reflects an execution result of the operation command, and the second type response data is not related to the execution result of the operation command; and
sending the response message to the host system to respond to the operation command.

20. The memory control circuit unit according to claim 19, wherein the operation command comprises one of a writing command, a reading command, and an erasing command.

21. The memory control circuit unit according to claim 19, wherein the second type response data reflects a status of the memory storage device before receiving the operation command or generating the response message.

22. The memory control circuit unit according to claim 21, wherein the status comprises at least one of a temperature status and a working status.

23. The memory control circuit unit according to claim 19, wherein the second type response data is stored in a reserved bit area in the response message.

24. The memory control circuit unit according to claim 19, wherein generating the response message according to the operation command by the memory management circuit comprises:
detecting an event configured to generate the response message;
reading a status data from a status register in response to the event, wherein the status data reflects a status of the memory storage device; and
filling the second type response data into the response message according to the status data during a generation of the response message.

25. The memory control circuit unit according to claim 24, wherein the memory management circuit is further configured for:
writing the status data into the status register before detecting the event configured to generate the response message.

26. The memory control circuit unit according to claim 24, wherein the memory management circuit is further configured for:
writing the status data into the status register before receiving the operation command.

27. The memory control circuit unit according to claim 24, wherein the status register comprises a plurality of sub-storage areas, the response message comprises a plurality of reserved bit areas, wherein filling the second type response data into the response message according to the status data by the memory management circuit comprises:
filling a first sub-data in the second type response data into a first reserved bit area in the response message according to a first status data read from a first sub-storage area in the plurality of sub-storage areas; and
filling a second sub-data in the second type response data into a second reserved bit area in the response message according to a second status data read from a second sub-storage area in the plurality of sub-storage areas,
wherein the first sub-storage area is different from the second sub-storage area, and the first reserved bit area is different from the second reserved bit area.
